(19) United States
(12) Patent Application Publication
(10) Pub. No.: US 2025/0215989 A1
(43) Pub. Date: Jul. 3, 2025

(54) HEAT RESPONSIVE VALVE FOR FLUIDS

(71) Applicant: Ausco, Inc., Farmingdale, NY (US)

(72) Inventors: Thomas TAYLOR, Farmingdale, NY (US); Matthew RUGGIERO, Farmingdale, NY (US)

(21) Appl. No.: 18/989,628

(22) Filed: Dec. 20, 2024

Related U.S. Application Data
(60) Provisional application No. 63/615,168, filed on Dec. 27, 2023.

(51) Int. Cl. F16K 31/00; F03G 7/06; F16K 3/26

(52) U.S. Cl. CPC F16K 31/002; F16K 3/26; F03G 7/06145

(57) ABSTRACT

A heat responsive control valve, comprising a valve body having a spool slidably positioned within an interior hollow cavity of the valve body, the valve body having one and preferably at least one fluid inlet and one, preferably at least one fluid outlet, the spool having at least one fluid inlet, a fluid cavity and at least one least one outlet preferably in a side wall thereof, and a heat responsive element which is used in controlling the relative position of the spool within the valve body. Methods of controlling fluid flow using the heat responsive valve are also disclosed.

The present invention claims priority to U.S. Ser. No. 63/615,168 filed 27 Dec. 2023, and incorporates that application herein in its entirety.

The present invention relates to a heat responsive control valve, useful in the controlled dispensation of fluids therefrom.

The control of fluids (i.e., gases, but especially fluids) is essential in a multitude of industrial applications and various apparatus in our world. Each apparatus and process will of course impose its own particular technical parameters necessary for effective control. In the case of control of fluids, particular technical considerations often arise, in providing effective control particularly over a long service life, including effective control of fluid control circuits. Such applications imposing such severe technical considerations include, i.e., medical, aerospace, oil and gas drilling, and similar applications. The heat responsive valve for fluids provided by the invention, as well as processes/methods utilizing the same, address these particular technical considerations.

In a first aspect, the present invention relates to a heat responsive control valve, comprising a valve body having a spool (or ‘poppet’) slidably positioned within an interior hollow cavity of the valve body, the valve body having one and preferably at least one fluid inlet and one, preferably at least one fluid outlet, the spool having at least one fluid inlet, a fluid cavity and at least one outlet preferably in a side wall thereof, and a heat responsive element which is used in controlling the relative position of the spool within the valve body. In a first position, a sidewall of the spool obscures and seals the at least one fluid outlet of the valve body, while in a second position the at least one outlet of the spool provides for passage of the fluid from its fluid cavity outward through the at least one fluid outlet of the valve body. The heat responsive element is desirably positioned within the heat responsive control valve such that when it reaches an elevated temperature it expands or contracts and induces slidable displacement of the spool within the interior hollow of the valve body. A compression spring, is also present within the heat responsive control valve and resists the slidable displacement, in a manner that when the heat responsive element is returned to below the elevated temperature, the compression spring returns the spool to its prior position, viz, the first position. The heat responsive element comprises or consists of a heat responsive metal alloy containing high percentages of nickel and titanium; such a material is a shape-memory metal alloy, and is frequently referred to commercially as “Nitinol.”

In a second aspect, the present invention relates to a heat responsive control valve, comprising a valve body having a spool slidably positioned within an interior hollow cavity of the valve body, the valve body having at least one fluid inlet at least a first fluid outlet and a second fluid outlet (and, optionally may contain still further fluid outlets, i.e., third fluid outlet, and still further fluid outlets) the spool having at least one fluid inlet, a fluid cavity and at least one least one outlet preferably in a side wall thereof, and a heat responsive element which is used in controlling the relative position of the spool within the valve body. In a first position, a sidewall of the spool obscures and seals the at least one fluid outlet of the valve body, and optionally one or more of the further fluid outlets which may be present in the valve body. Alternately, in a first position, a sidewall of the spool obscures and seals at least one fluid outlet of the valve body, and optionally also one or more of the further fluid outlets which may be present in the valve body, but allows for fluid to pass out of the fluid cavity of the spool and outwardly through at least one fluid outlet of the valve body. In a second position, at least one outlet of the spool provides for passage of the fluid from its fluid cavity outward through at least one of the fluid outlets of the valve body, and in a certain embodiment outwardly through two or more of the fluid outlets present in the valve body. The heat responsive element is desirably positioned within the heat responsive control valve such that when it reaches an elevated temperature it expands and induces slidable displacement of the spool within the interior hollow of the valve body. A compression spring is also present within the heat responsive control valve and resists the slidable displacement, in a manner such that when the heat responsive element is returned to below the elevated temperature, the compression spring returns the spool to its prior position, viz, the first position. The heat responsive element comprises or consists of a heat responsive a shape-memory metal alloy, i.e., “Nitinol” as described herein.

In a still further, third aspect of the invention there is provided a heat responsive control valve according to the first or second aspects, which further includes a control stem having a part or an end depending from or affixed to a part of the spool, and a further part or an end extending outwardly from the valve body.

In a fourth aspect of the invention, there is provided a heat responsive control valve according to the first or second aspects, which further includes a control stem having a part or an end depending from or affixed to a part of the spool, and a manual control element extending outwardly from the valve body and which may be used to position or reposition the spool within the valve body.

In the heat responsive element, a shape-memory metal alloy, particularly where it is Nitinol, when it is heated to a target, or so-called elevated temperature (or temperature range), the atoms arrange themselves into a cubic, highly symmetrical arrangement known as the austenite phase. After the heat responsive element has cooled down, the piece will enter the martensite phase and can be deformed into various shapes. When the heat responsive element is reheated to the austenite phase (a transition temperature that varies with the particular shape-memory metal alloy) the heat responsive element will “remember” the original or parent shape and exert a great force to return to that shape if the piece is in anyway constrained from returning. All of these phase changes occur while the Nitinol remains a solid, only the crystal structure changes as described.

Nitinol is typically composed of approximately 55% nickel and 45% titanium by weight, but other relative amounts of nickel and titanium may also be utilized, namely may be wherein the atomic percentages of both metals are equal or nearly equal, preferably where nickel is within +/−20% of titanium. Further metals may be present, but if present are usually in substantially lesser concentrations than the nickel and titanium which comprise the bulk of the Nitinol material. The control of the relative atomic ratios (concentrations) of nickel and titanium permits for a degree of control of the transition temperature of the Nitinol, and allows for the actuation temperature to be tailored for the application. In the context of the present invention, the composition of the heat responsive element is such that the rearrangement of atoms to the austenite phase occurs when the heat responsive element is in the range of about 60° C. to about 80° C.

Certain preferred embodiments of heat responsive control valve are discussed with reference to the accompanying figures, which form an integral part of this application. In the various drawing figures, presenting various embodiments and views, reference numbers a/o letters a/o labels are used consistently with reference to these drawings.

According to certain particularly preferred embodiments, the fluid used with the heat responsive control valve according to the invention particularly in the embodiments disclosed and discussed herein are non-gas fluids, that is to say are incompressible or substantially incompressible liquids. However, notwithstanding the foregoing, the fluid may be a gas or gaseous vapor.

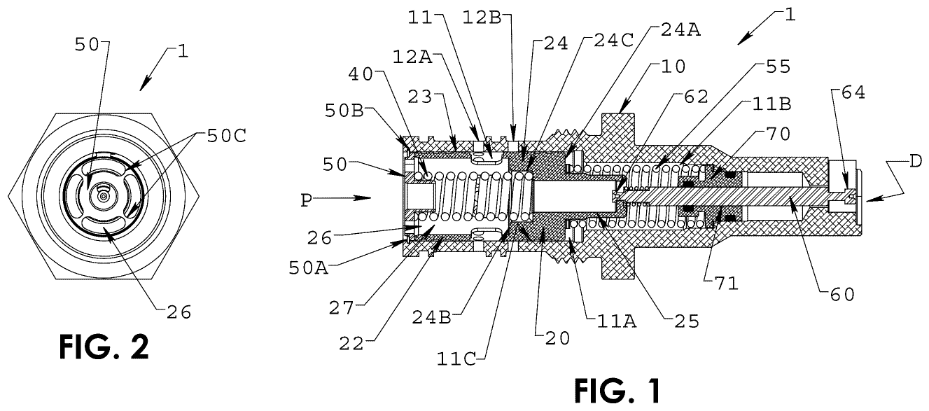

FIGS. 1 through 4 depict various views of a heat responsive control valve according to the invention.

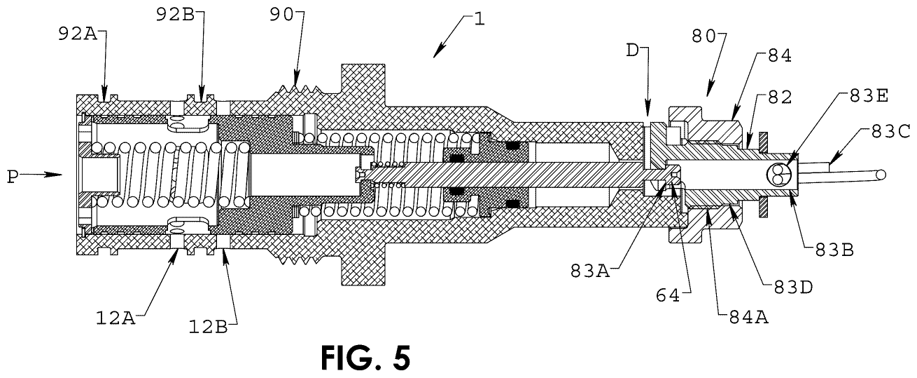

FIGS. 5 though 8B depict in various views of a heat responsive control valve according to the invention which further includes a manual control element extending outwardly from the valve body and which may be used to position or reposition the spool within the valve body, particularly as shown in FIGS. 1 through 4.

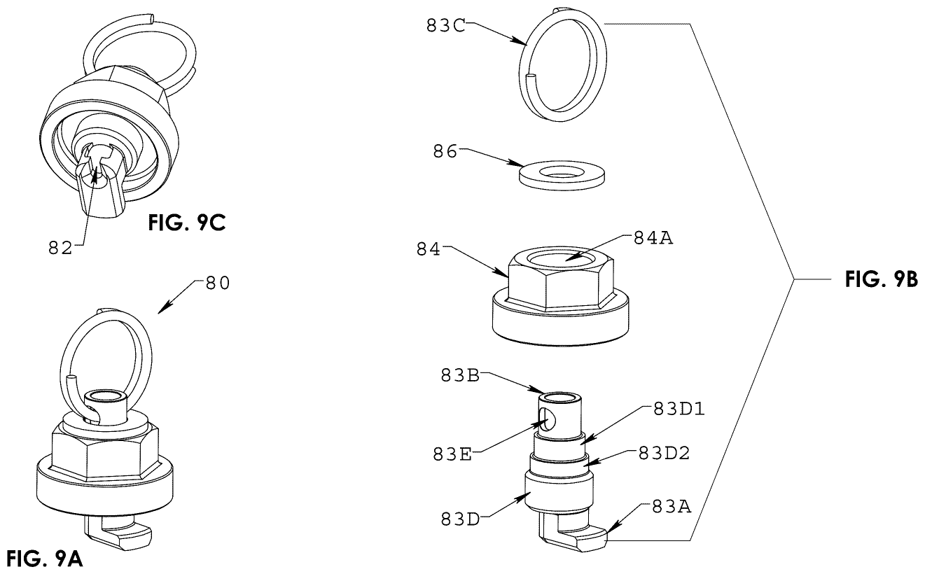

FIGS. 9A and 9B illustrate views of a manual control element useable with the heat responsive control valve.

Turning now to various views of FIGS. 1 through 4, a heat responsive control valve 1 is depicted, and for sake of convenient reference the inlet and is defined to be the “proximal” end and reference is understood from the label “P” and arrow, while the opposite “distal end” is to be understood from the label “D” and its arrow. In the preferred embodiment the valve body 10 may be understood as having a theoretical central axis extending between its proximal and distal ends.

The valve body 10 has within its interior hollow cavity 11 in the form of a stepped bore a wider bore section 11A extending inwardly from the distal end D, and contiguous therewith a narrower bore section 11B, having a slightly smaller diameter than bore section 11A. Within the hollow cavity 11, is present the slidable spool 20. The spool 20 has a base section 22 having a spool sidewall 23 which is slidably engaged within the hollow cavity 11, and in particular the wider bore section 11A, such that a seal tight interfacial contact between the spool sidewall 23 and the inner sidewall 11C of bore section 11A. It is to be noted that in certain embodiments the interfacial contact may be adjusted, to allow for a permissible degree of leakage, or may include one or more sealing members, which for example may be o-rings, washers, gaskets, and the like effective in providing a fluid tight seal. The spool 20 further includes a transverse end section 24 present between the base section 22 and a top section 25 which extends and depends from the transverse ends and extends in the opposite direction from the base section 22, which also depends from this transverse end section 24. The transverse end section 24 also provides both a fluid tight end of the base section 22, and is also used in defining the fluid cavity 27 of the spool 20 which fluid cavity 27 is bounded by the transverse end section 24, the spool sidewall 23 and the open base 26 of the spool, through which fluid is introduced into the fluid cavity 27. The transverse end section 24 includes a top face 24A extending transversely and terminating with sidewall 23, and also includes a bottom face 24B within the interior of the fluid cavity 27. Within this bottom face 24B is present a recess 24C, a distal end 40A of which is used to seat a part of a heat responsive element 40 present with both the bore section 11A and fluid cavity 27. The other, proximal end 40B is seated upon a retention element 50, which itself is held in place by a retainer 50A, which may for example be a snap ring or retaining ring engaged in a groove 50B of the valve body 20. The retention element 50 spans the bore section 11A and concurrently provides a structural support for the proximal end 40B of the heat responsive element 40 against which it may be compressed. The retention element 50 also includes one or more fluid passages 50C to ensure the entry of fluid into the interior of both the bore section 11A and fluid cavity 27, and thus is at the inlet of the heat responsive control valve 1.

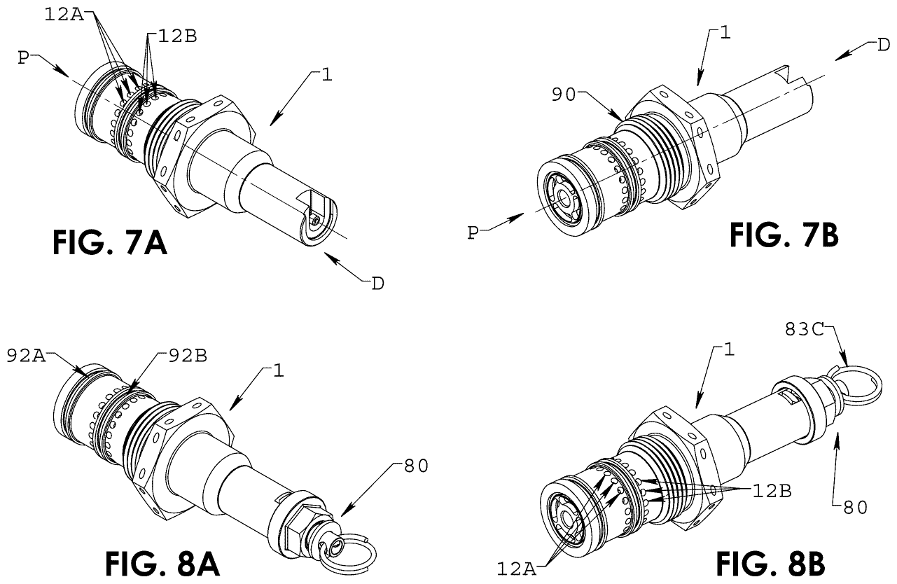

With particular reference to the lower part of the valve body 10 in the region of the bore section 11A and the base section 22 of the spool 20, and to FIG. 4, at least one fluid outlet 12A is provided in the valve body 10 in the form of a transverse passage (hole) passing through the valve body 10. At least one second fluid outlet 12B is also illustrated in the figures which is linearly displaced from the at least one fluid outlet 12A. In the preferred embodiments, as shown in all the drawing figures, at least one fluid outlet 12A is preferably a series of radial and coplanar transverse passages perpendicular to the valve body 10 and within the region of the bore section 11A. When present (though not essential to all aspects of the present invention) at least one second fluid outlet 12B is similarly provided by a series of radial and coplanar transverse passages perpendicular to the valve body 10, within the region of bore section 11A, but linearly offset and separated from the plurality of fluid outlets 12A, as may be best seen from FIGS. 7A through 8B which provide isometric views. Further it is to be understood that although not depicted in any of the drawing figures presently provided, it is readily foreseen that if necessary or desirable that at least a third (or greater number) fluid outlet(s) can be similarly provided, by one or more, preferably a similar series of radial and coplanar transverse passages perpendicular to the valve body 10 within the region of the bore section 11A, but separated from any other extant fluid outlets present in the valve body 10. Any plurality of such series of fluid outlets may be present, being only limited by the physical dimensions of the valve body 10.

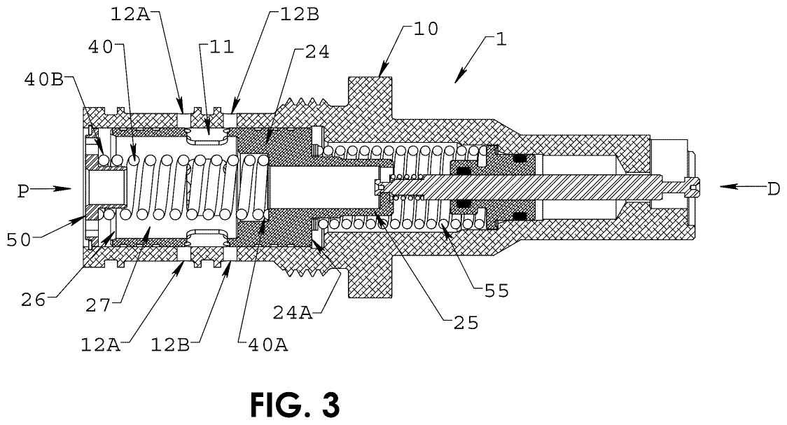

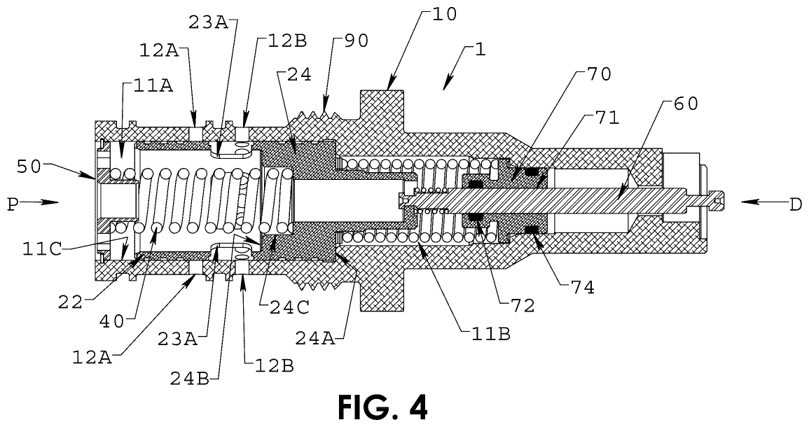

Fluid passing between the fluid cavity 27 of the spool 20 and any of the fluid outlets (i.e., 12A, 12B) is controlled by the relative position of the spool 20 within the valve body 10. The spool 20 includes in its sidewall 23 at least one valve passage 23A, which defines a fluid flow passage(s) from the fluid cavity 27 and to at least one of the fluid outlets, e.g., 12A, 12B and if present, further fluid outlets. The relative position of the spool 20 within the valve body 10 controls the fluid passing from the fluid cavity 27 through the at least one valve passage 23A, thereafter through one or more of the fluid outlets, i.e, 12A and/or 12B, and outwardly from the valve body 10. The spool 20 being linearly displaceable along the length of the valve body 10 and in particular within the base section 22 permits for one or more of the fluid outlets, i.e, 12A and/or 12B, to eclipsed and thus block for the passage of fluid from such eclipsed fluid outlets, while other(s) of the fluid outlets are open to the passage of fluid flow therethrough. This relationship is understood and illustrated in sequence, when considering FIG. 1, next FIG. 3 and thereafter FIG. 4. Viewing FIG. 1, the position of the spool 20 and its valve passage 23A is such that fluid outlet 12A is uneclipsed and open to the interior of the fluid cavity 27, thereby allowing for fluid to flow out from the fluid cavity 27, and via fluid outlet 12A and outwardly from the valve body 10. Simultaneously fluid outlet 12B is eclipsed by the spool sidewall 23, forming a fluid tight seal and denying passage outwardly through fluid outlet 12B. Next, as seen in FIG. 3, the spool 20 is linearly displaced within the valve body 10 and in particular bore section 11A, in the distal direction. As is herein seen, the valve passage 23A is now positioned such that neither fluid outlet 12A or 12B are eclipsed, and in this position fluid within the fluid cavity 27 may flow through both of fluid outlets 12A and 12B and outwardly from the valve body 10. Next, as seen in FIG. 4, the valve passage 23A has now been shifted further linearly along the valve body 10 in a distal direction, such that fluid out 12A is eclipsed by the sidewall 23 of the spool 20, while the fluid 12A outlet is aligned such that only fluid outlet 12B is in fluid communication with the fluid cavity 27 via the valve passage 23A.

Movement of the spool 20 is primarily controlled by the linear dimension of the heat responsive element 40, which in this embodiment is in the form of a helical wire shape, such when heated, to a target temperature, it's length in a linear direction is increased as it internally conforms to its austenite phase configuration. This urges the spool 20 in the distal direction, and induces movement of the spool. However below the target temperature, the internal conformation reverts to the martensite phase configuration at below the target temperature, and the linear direction is decreased. As the return to the martensite internal configuration reduces the length between the two ends of the heat responsive element 40, a compression spring 55 of a non-phase change material, i.e, a metal spring present within the valve body 10, in particular in bore section 11B. The compression spring 55 exhibits classical elasticity whose elastic characteristics are not primarily temperature dependent. As is visible in the figures, and in particular FIGS. 1, 3 and 4 the compression spring 22 is within the bore section 11B having its distal end seated against one part of the bore section 11B, and its proximal end seated against top face 24A of the transverse end section 24 of the spool 20 and in part surrounding the top section 25. When the heat responsive element 40 extends linearly between its two ends, causing linear displacement of the spool 20 the compression spring 55 is compressed, as its length between its ends is reduced. When the heat responsive element 40 falls below its target temperature and its length is reduced, as the heat responsive element 40 does not exhibit classical elasticity, the compressed compression spring 25 extends in length, and causes spool 20 to be linearly displaced towards the proximal end of the valve body 10, and urges against the heat responsive element 40 reducing its linear length.

With reference to the compression spring 55 of a non-phase change material, in certain embodiments such is replaced by a heat responsive element, a shape-memory alloy, i.e., “Nitinol.” In such embodiments both the heat responsive element 40 and the compression spring 55 are both of a shape-memory alloy. However in this embodiment the target temperatures of the heat responsive element 40 and the compression spring 55 are different such that while of these elements is assuming or has assumed the austenite phase, the other of these elements is assuming or has assumed martensite phase.

In the illustrated preferred embodiments depicted in the various drawing figures, there is shown an optional, but many cases preferably included control stem 60, having a central part extending through a stem guide 70. A proximal end 62 of the control stem 60 is affixed to a part of the spool 20, here at a part of the top section 25, while a distal end 64 of the control stem 60 extends outwardly from the valve body 10. The stem guide 70 includes a central bore 71, and includes two sealing members, which for example may be o-rings, washers, gaskets and the like. A first sealing member 72 provides a fluid tight seal against the control stem 60, while the second sealing member 74 provides a tight seal against the interior of the valve body 20. The inclusion of the control stem 60 allows for the positioning of the spool 20 to be established by means wholly independent of the temperature of the fluid within the valve 1, and functions independently of the heat responsive element 40 and the compression spring 25. As the distal end 64 extends out of the valve body 10 it may be mechanically grasped and displaced linearly, such as appreciated again from a sequential consideration of FIG. 1, then FIG. 3, and finally FIG. 4. This may be useful for example, as a simple indicator as to the relevant and current placement of the spool 20 within the valve body 10, which is not visible to the naked eye as, the relative position of, or alternately the height of this distal end 64 relative to the valve body 10 provides a visual indicator of the current linear position of the spool 20, and correspondingly which of the fluid outlets 12A, 12B are eclipsed and which may be open to fluid flow.

The provision of a control stem 60 in a heat responsive control valve 1 of the invention facilitates the removable attachment of a manual control element 80 extending outwardly from the valve body 10. Alternatively the manual control element may be permanently affixed and form an integral part of the heat responsive control valve 1. The manual control element 80 may be used to manually position or reposition the spool 20 within the valve body 10, by facilitating the linear movement of the control stem 60 and maintaining it at a desired position relative to the valve body 10. This of course provides direct control of the position of the spool 20 and corresponding control over the flow of fluid through the heat responsive control valve 1, which control is independent of the temperature of the fluid within. Further features of the manual control element 80 are hereinafter discussed with relation to FIGS. 9A and 9B.

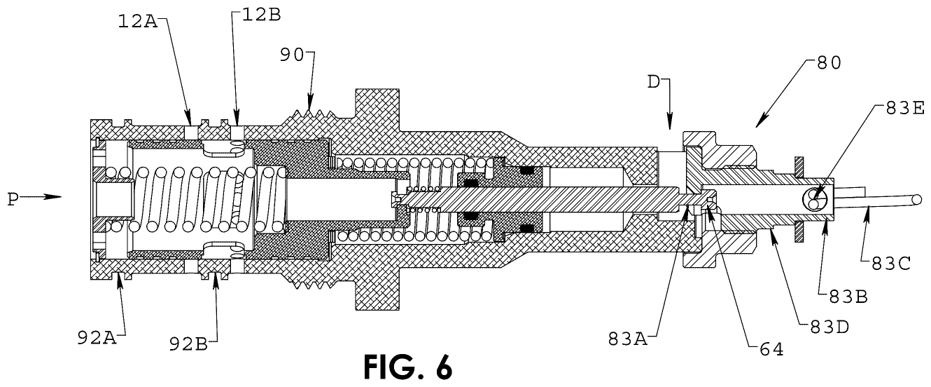

With attention now to FIGS. 5 and 6, therein is illustrated a manual control element 80 extending outwardly from the valve body 10, in two different positions. The manual control element 80 has a latching part 82 mechanically affixed at latch end 83A to the distal end 64 of the control stem 60, and at its opposite end 83B an eyelet 83E through which may optionally extend a ring 83C or the like. Intermediate the latch end 83A and its opposite end 83B there is a generally cylindrical guide section 83D, which is moveable and reversibly lockable with a corresponding section 84A of a locking collar 84. The interface between the guide section 83D and the corresponding section 84A may include surface features which facilitate the retention of these two sections together but preferably, in reversible manner. In use, a person, operator, or conceivably also a linkage to a further control device such as a solenoid or motor may be affixed to the latching part 82, and used to push or pull the control stem 60, and thereafter optionally but preferably, locking it in a desired position. Thus, independent of the heat responsive element 40 and the compression spring 55, the spool 20 may be held in a desired position within the valve body 10 of the heat responsive control valve 1, and its flow control operation established. Provision of such a manual control element 80 may be particularly advantageous in certain applications. The provision of such a manual control element 80 also provides a visual indicator of the current linear position of the spool 20, and correspondingly which of its fluid outlets (i.e., 12A, 12B, etc.) are eclipsed and which may be open to fluid flow through the heat responsive control valve 1.

The heat responsive control valve 1 is intended to be form part of a part of a larger or further apparatus, such as a valve control body, manifold, or the like in which control of a fluid using the heat responsive control valve 1 is desired. In such a larger or further apparatus a suitably sized receiving bore (not shown) is configured to receive and retain within it, at least the proximal end of the valve body 10. To facilitate its retention, and sealing of internal fluid passages within such a larger or further apparatus, optionally but preferably mating threads 90 are provided on a portion thereof, which are designed and configured to engage with corresponding set of threads present on such a larger or further apparatus (not shown). Of course retention of the heat responsive control valve 1 can be attached to/seated within the larger or further apparatus by any other means, i.e., may be press fit, a retention flange, and the like. Similarly, optionally but preferably the valve body 10 include one or two, or more if necessary, circumferential channels, 92A, 92B which are used to receive and retain within a corresponding sealing member, such as o-rings, washers, gaskets and the like.

Turning now to FIGS. 9A and 9B, the former figure illustrates the embodiment of the manual control element 80, as shown in FIGS. 5 and 6, albeit detached from the valve body 10. The latter FIG. 9B illustrates the manual control element 80 in an exploded view. As is best understood from FIG. 9B, the latching part 82 is mechanically affixed at latch end 83A to the distal end 64 of the control stem 60, and at its opposite end 83B an eyelet 83E through which may optionally extend a ring 83C or the like. The provision of the ring 83C is useful in providing various functions, including proving an element wherein a finger or tool may be inserted to push or pull the latching part 82, thereby imparting movement to the control stem 60. A further function is to retain a tag, label or the like which may be used to visually identify the particular valve 1 and/or its operational status. A circumferential washer 86 is also depicted and is preferably included. Intermediate the latch end 83A and its opposite end 83B there is the generally cylindrical guide section 83D which is moveable and reversibly lockable with a corresponding section 84A of a locking collar 84. In FIG. 9B, is more clearly visible that the guide section 83D has is ‘stepped’ and comprises two stepped sections 83D1, 83D2 which are concentric but of differing diameters. These stepped sections 83D1, 83D2 facilitate the retention of these latching part 82 within the locking collar 84, preferably in a resettable or reversible manner. As noted above, using a manual control element 80, independent of the heat responsive element 40 and the compression spring 55, the spool 20 may be held in a desired position within the valve body 10 of the heat responsive control valve 1, and its flow control operation established. In certain embodiments the manual control element 80 is permanently affixed to or forms an integral part of the heat responsive control valve 1 according to the invention, but in other embodiments it may be removed and reattached when desired.

The heat responsive control valve 1 is used in controlling the exiting flow therefrom, of a fluid (which fluid is preferably a liquid, including an incompressible or substantially incompressible liquid) is governed by the position of the spool 20 relative to at least one, probably at least two or more fluid outlets, i.e. 12A, 12B and further outlets, wherein the control of the fluid is governed by the temperature of the fluid within the fluid cavity 27 of the spool 20 and the configuration at the fluid temperature of the heat responsive element 40. For example, in one manner of use, a control fluid is dispensed outwardly from one of the fluid outlets until it reaches a target fluid temperature, which is similar to the target, so-called elevated temperature (or temperature range) of the heat responsive element 40, which then extends its linear dimension and closes this fluid outlet, and opens fluid flow out to a further fluid outlet which may for example be connected to a cooler or heat exchanger which reduces the temperature of the control fluid. The fluid within the heat responsive control valve 1 will continue to be allowed to flow out from the further fluid outlet until it cools to below the target temperature, at which point the heat responsive element 40 returns to its prior configuration, the compression spring 55 urging the spool 20 linearly in the direction of the heat responsive element 40, and closing the further fluid outlets which has been previously opened to fluid flow.

Alternately, or in addition thereto, the operation of the heat responsive control valve 1 may be controlled by suitable, manual positioning of the spool 20 within the valve body 10, using a manual control element 80.

1. A heat responsive control valve comprising a valve body having a spool slidably positioned within an interior hollow cavity of the valve body, the valve body having at least one fluid inlet and one, at least one fluid outlet, the spool having at least one fluid inlet, a fluid cavity and at least one least one outlet in a side wall thereof, and a heat responsive element comprises or consists of a heat responsive shape-memory metal alloy which operates to control the relative position of the spool within the valve body,
wherein the heat responsive control valve may be configured to assume a first position wherein a sidewall of the spool obscures and seals the at least one fluid outlet of the valve body, and may be configured to assume a second position wherein the at least one outlet of the spool provides for passage of the fluid from its fluid cavity outward through the at least one fluid outlet of the valve body,
and wherein the heat responsive control valve, induces slidable displacement of the spool within the interior hollow of the valve body.

2. The heat responsive control valve of claim 1, wherein movement of the spool is primarily controlled by the linear dimension of the heat responsive element, which depending upon the temperature of the heat responsive element, assumes either an austenite phase configuration and concurrently an expanded linear direction when at or above a target temperature, but concurrently assumes a martensite phase configuration at below the target temperature and a decreased linear dimension.

3. The heat responsive control valve of claim 1, wherein the heat responsive element is in the form of a helical coil.

4. The heat responsive control valve of claim 1, which further comprises a control stem having a part or an end depending from or affixed to a part of the spool, and a further part or an end extending outwardly from the valve body, and optionally a manual control element extending outwardly from the valve body and which may be used to position or reposition the spool within the valve body.

5. The heat responsive control valve of claim 1, which comprises both a first fluid outlet and a second fluid outlet, and
wherein the heat responsive control valve may be configured to assume a first position wherein a sidewall of the spool obscures and seals the at least one fluid outlet of the valve body but allows for fluid to pass out of the fluid cavity of the spool and outwardly through at least one fluid outlet of the valve body, and may be configured to a second position wherein the at least one outlet of the spool provides for passage of the fluid from its fluid cavity outward through both the first fluid outlet and a second fluid outlet of the valve body.

6. The heat responsive control valve of claim 5, wherein movement of the spool is primarily controlled by the linear dimension of the heat responsive element, in the form of a helical coil, which depending upon the temperature of the heat responsive element, assumes either an austenite phase configuration and concurrently an expanded linear direction when at or above a target temperature, but concurrently assumes a martensite phase configuration at below the target temperature and a decreased linear dimension.

7. The heat responsive control valve of claim 5, which further comprises a control stem having a part or an end depending from or affixed to a part of the spool, and a further part or an end extending outwardly from the valve body, and optionally a manual control element extending outwardly from the valve body and which may be used to position or reposition the spool within the valve body.

8. A method of controlling the fluid of flow in response to the fluid's temperature, the method comprising the steps of:
providing the heat responsive control valve according to claim 1 to a further apparatus requiring fluid flow control,
operating the heat responsive control valve to control the flow of a fluid therethrough.
